(19) United States
(12) Patent Application Publication
(10) Pub. No.: US 2026/0276875 A1
(43) Pub. Date: Sep. 17, 2026

(54) OPTICAL FILTER, DISPLAY DEVICE INCLUDING THE OPTICAL FILTER, AND ELECTRONIC DEVICE INCLUDING THE SAME

(71) Applicant: Samsung Display Co., Ltd., Yongin-si (KR)

(72) Inventors: Soo Bin KIM, Yongin-si (KR); Yong Seok KIM, Yongin-si (KR); Ji Young NAM, Yongin-si (KR); Dong Chul SHIN, Yongin-si (KR); Hae Ju YUN, Yongin-si (KR); Jong Cheon LEE, Yongin-si (KR)

(21) Appl. No.: 19/329,222

(22) Filed: Sep. 15, 2025

(30) Foreign Application Priority Data
Mar. 11, 2025 (KR) 10-2025-0031376

(51) Int. Cl. G02B 5/28

(52) U.S. Cl. CPC G02B 5/28

(57) ABSTRACT

An optical filter, a display device including the optical filter, and an electronic device including the same are provided. The display device may include a light source that outputs light, a spatial light modulator that modulates phase or amplitude of light output from the light source, and an optical filter that filters light provided from the spatial light modulator. The optical filter may include a substrate, a first layer on one side of the substrate, a second layer on the first layer, and a third layer on the second layer. The first layer, the second layer, and the third layer may include materials different from one another. A height of the first layer, a height of the second layer, and a height of the third layer may be different from one another.

### CROSS-REFERENCE TO RELATED APPLICATION

The present application claims priority to and the benefit of Korean Patent Application No. 10-2025-0031376, filed on Mar. 11, 2025, in the Korean Intellectual Property Office, the entire content of which is hereby incorporated by reference.

### BACKGROUND

### 1. Technical Field

Embodiments of the present disclosure relate to an optical filter, a display device including the optical filter, and an electronic device including the display device.

### 2. Description of the Related Art

With the advancement of the information society, various types (or kinds) of display devices that display information have been developed. For example, an augmented reality (AR) device is a display device that superimposes a virtual image on an image of reality seen by a user’s eyes. As another example, a stereoscopic image display device is a display device that displays a left-eye image and a right-eye image separately to provide a stereoscopic effect depending on binocular parallax. As another example, a holographic display device is a display device that displays a stereoscopic image by providing information on amplitude and information on phase.

In a holographic display device, a spatial light modulator is used. The spatial light modulator is categorized into an amplitude modulation mode that modulates the amplitude of incident light and outputs the modulated amplitude, and a phase modulation mode that modulates the phase of incident light and outputs the modulated phase. In the spatial light modulator, not only a signal intended to be provided to a user but also conjugate noise and direct current (DC) noise are generated. In this regard, various methods to provide only the signal to a user by removing noise are being studied.

### SUMMARY

Aspects of embodiments of the disclosure provide an optical filter that filters noise generated in a spatial light modulator.

Aspects of embodiments of the disclosure provide a display device including an optical filter that filters noise generated in a spatial light modulator.

Aspects of embodiments of the disclosure provide an electronic device including a display device including an optical filter that filters noise generated in a spatial light modulator.

Aspects of embodiments of the disclosure are not limited to those mentioned above and additional aspects of embodiments of the disclosure, which are not mentioned herein, will be clearly understood by those skilled in the art from the following description of the disclosure.

According to some embodiments of the disclosure, a display device may include a light source that outputs light, a spatial light modulator that modulates phase or amplitude of light output from the light source, and an optical filter that filters light provided from the spatial light modulator. The optical filter may include a substrate, a first layer on one side of the substrate, a second layer on the first layer, and a third layer on the second layer. The first layer, the second layer, and the third layer may include materials different from one another. A height of the first layer, a height of the second layer, and a height of the third layer may be different from one another. The third layer may include a plurality of structures that extend in a first direction and that are provided in a second direction perpendicular (e.g., substantially perpendicular) to the first direction.

According to some embodiments, the height of the second layer and the height of the third layer may be proportional to the height of the first layer.

According to some embodiments, the height of the first layer may be in a range from 85 nm to 87 nm.

According to some embodiments, the height of the second layer may be in a range from 78 nm to 80 nm.

According to some embodiments, the height of the third layer may be in a range from 98 nm to 100 nm.

According to some embodiments, the plurality of structures may be respectively provided to be spaced apart from each other by a first interval in the second direction.

According to some embodiments, the height of the first layer, the height of the second layer, and the height of the third layer may be proportional to the first interval.

According to some embodiments, the first interval may be in a range from 329 nm to 331 nm.

According to some embodiments, a width of each of the plurality of structures may be half of the first interval.

According to some embodiments, a ratio of an area in which the plurality of structures are provided to an area of the third layer may be in a range from 0.48 to 0.52.

According to some embodiments, the spatial light modulator may be a reflective spatial light modulator that reflects the light.

According to some embodiments, the spatial light modulator may be a transmissive spatial light modulator that transmits the light.

According to some embodiments of the disclosure, an electronic device may include a display device. The display device may include a light source that outputs light, a spatial light modulator that modulates phase or amplitude of light output from the light source, and an optical filter that filters light provided from the spatial light modulator. The optical filter may include a substrate, a first layer on one side of the substrate, a second layer on the first layer, and a third layer on the second layer. The first layer, the second layer, and the third layer may include materials different from one another. A height of the first layer, a height of the second layer, and a height of the third layer may be different from one another. The third layer may include a plurality of structures that extend in a first direction and that are provided in a second direction perpendicular to the first direction.

According to some embodiments of the disclosure, an optical filter may include a substrate, a first layer on one side of the substrate, a second layer on the first layer, and a third layer on the second layer. The first layer, the second layer, and the third layer may include materials different from one another. A height of the first layer, a height of the second layer, and a height of the third layer may be different from one another. The third layer may include a plurality of structures that extend in a first direction and that are provided in a second direction perpendicular (e.g., substantially perpendicular) to the first direction.

According to some embodiments, the height of the second layer and the height of the third layer may be proportional to the height of the first layer.

According to some embodiments, the height of the first layer may be in a range from 85 nm to 87 nm.

According to some embodiments, the height of the second layer may be in a range from 78 nm to 80 nm.

According to some embodiments, the height of the third layer may be in a range from 98 nm to 100 nm.

According to some embodiments, the plurality of structures may be respectively provided to be spaced apart from each other by a first interval in the second direction.

According to some embodiments, the first interval may be in a range from 329 nm to 331 nm.

In an optical filter, a display device including the optical filter and an electronic device including the display device according to some embodiments of the disclosure, only light of a set of specific wavelength, which is vertically incident, may be reflected, and the remaining light may be transmitted, so that noise generated in the spatial light modulator may be effectively reduced.

In the related art, a size of a display device is increased and an optical system becomes longer to avoid noise using a lens having a long focal length or to filter noise using a plurality of lenses and filters. In embodiments, the optical filter of the disclosure has a very thin thickness of several hundred nanometers, so that it can facilitate the thinning of the display device.

In some embodiments of the disclosure, if (e.g., when) the plurality of optical filters are used, arrangement directions of a plurality of structures of a third layer are provided to be different from each other, so that noise may be reflected without restrictions in polarization.

Effects according to embodiments of the disclosure are not limited to those mentioned above and other suitable various effects are included in the following description of the disclosure.

### BRIEF DESCRIPTION OF THE DRAWINGS

The above and other embodiments and features of embodiments of the disclosure will become more apparent by describing embodiments thereof with reference to the attached drawings, in which:

FIG. 1 is a perspective view illustrating an optical filter according to some embodiments of the disclosure;

FIG. 2 is a side view illustrating an example of the optical filter of FIG. 1;

FIG. 3 is a side view illustrating a display device including an optical filter according to some embodiments of the disclosure;

FIG. 4 is an example view illustrating an example embodiment of the second light of FIG. 3;

FIG. 5 is a graph illustrating light transmittance and reflectance of the optical filter of FIG. 1;

FIGS. 6 to 8 are views illustrating transmission and reflection with respect to an incident angle of the optical filter of FIG. 1;

FIG. 9 is a side view illustrating a display device including an optical filter according to some embodiments of the disclosure;

FIG. 10 is a block diagram illustrating an electronic device including a display device including an optical filter according to some embodiments of the disclosure;

FIG. 11 is an exemplary view illustrating an electronic device including a display device including an optical filter according to some embodiments of the disclosure.

### DETAILED DESCRIPTION

Aspects and features of embodiments of the present disclosure and methods of accomplishing the same may be understood more readily by reference to the detailed description of embodiments and the accompanying drawings. Hereinafter, embodiments will be described in more detail with reference to the accompanying drawings. The described embodiments, however, may be embodied in various suitable different forms, and should not be construed as being limited to only the illustrated embodiments herein. Rather, these embodiments are provided as examples so that the present disclosure will be thorough and complete, and will fully convey the aspects and features of embodiments of the present disclosure to those skilled in the art. Accordingly, processes, elements, and techniques that are not necessary to those having ordinary skill in the art for a complete understanding of the aspects and features of embodiments of the present disclosure might not be described.

Unless otherwise noted, like reference numerals, characters, or combinations thereof denote like elements throughout the attached drawings and the written description, and thus, repeated descriptions thereof may not be repeated. Further, parts not related to the description of one or more embodiments might not be shown to make the description clear.

In the drawings, the relative sizes of elements, layers, and regions may be exaggerated for clarity. The use of cross-hatching and/or shading in the accompanying drawings may generally be provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, and/or the like, of the elements, unless otherwise specified.

Various suitable embodiments are described herein with reference to sectional illustrations that are schematic illustrations of embodiments and/or intermediate structures. As such, suitable variations from the shapes of the illustrations as a result, for example, of manufacturing techniques and/or tolerances, are to be expected. Further, specific structural or functional descriptions disclosed herein are merely illustrative for the purpose of describing embodiments according to the present disclosure. Thus, embodiments disclosed herein should not be construed as limited to the particular illustrated shapes of regions, but are to include deviations in shapes that result from, for example, manufacturing.

For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not necessarily intended to illustrate the actual shape of a region of a device and are not intended to be limiting. Additionally, as those skilled in the art would realize, the described embodiments may be modified in various suitable different ways, all without departing from the spirit or scope of the present disclosure.

In the detailed description, for the purposes of explanation, numerous specific details are set forth to provide a thorough understanding of various suitable embodiments. It should be apparent, however, that various suitable embodiments may be practiced without these specific details or with one or more equivalent arrangements. In embodiments, certain structures and devices are shown in block diagram form to avoid unnecessarily obscuring various embodiments.

Spatially relative terms, such as “beneath,” “below,” “lower,” “under,” “above,” “upper,” and/or the like, may be used herein for ease of explanation to describe one element or feature’s relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, if (e.g., when) a first part is described as being “on” a second part, this indicates that the first part is provided at an upper side or a lower side of the second part without the limitation to the upper side thereof on the basis of the gravity direction.

Further, in this specification, the phrase “on a plane,” or “in a plan view,” means viewing a target portion from the top, and the phrase “on a cross-section” or “in a cross-sectional view” means viewing a cross-section formed by vertically cutting a target portion from the side.

It will be understood that if (e.g., when) an element, layer, region, or component is referred to as being “formed on,” “on,” “connected to,” or “coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. For example, if (e.g., when) a layer, region, or component is referred to as being "electrically connected" or "electrically coupled" to another layer, region, or component, it can be directly electrically connected or coupled to the other layer, region, and/or component or intervening layers, regions, or components may be present. However, “directly connected/directly coupled” refers to one component directly connecting or coupling another component without an intermediate component. In embodiments, other expressions describing relationships between components such as “between,” “immediately between” or “adjacent to” and “directly adjacent to” may be construed similarly. In embodiments, it will also be understood that if (e.g., when) an element or layer is referred to as being “between” two elements or layers, it can be the only element or layer between the two elements or layers, or one or more intervening elements or layers may also be present.

For the purposes of the present disclosure, expressions such as “at least one of,” “one of,” and “selected from,” if (e.g., when) preceding a list of elements, modify the entire list of elements and do not modify the individual elements of the list. For example, “at least one of X, Y, and Z,” “at least one of X, Y, or Z,” and “at least one selected from the group consisting of X, Y, and Z” may be construed as X only, Y only, Z only, any combination of two or more of X, Y, and Z, such as, for instance, XYZ, XYY, XZ, YZ, and ZZ, or any suitable variation thereof. Similarly, the expression such as "at least one of A and/or B" may include A, B, or A and B. As used herein, the term “and/or” includes any and all combinations of one or more of the associated listed items. For example, the expression such as "A and/or B" may include A, B, or A and B. Further, the use of “may” if (e.g., when) describing embodiments of the present disclosure refers to “one or more embodiments of the present disclosure".

It will be understood that, although the terms “first,” “second,” “third,” and/or the like, may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “include,” “includes,” “including,” “comprise,” “comprises,” “comprising,” “have,” “having,” “includes,” and “including,” if (e.g., when) used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ± 30%, 20%, 10%, 5% of the stated value. Further, the use of “may” if (e.g., when) describing embodiments of the present disclosure refers to “one or more embodiments of the present disclosure.”

If (e.g., when) one or more embodiments may be implemented differently, a specific process order may be performed differently from the described order. For example, two consecutively described processes may be performed substantially at the same time or performed in an order opposite to the described order.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, for example, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

The electronic or electric devices and/or any other relevant devices or components according to one or more embodiments of the present disclosure described herein may be implemented utilizing any suitable hardware, firmware (e.g., an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning for example consistent with their meaning in the context of the relevant art and/or the present specification, and should not be interpreted in an idealized or overly formal sense, unless expressly so defined herein.

Example embodiments are described below with reference to the attached drawings.

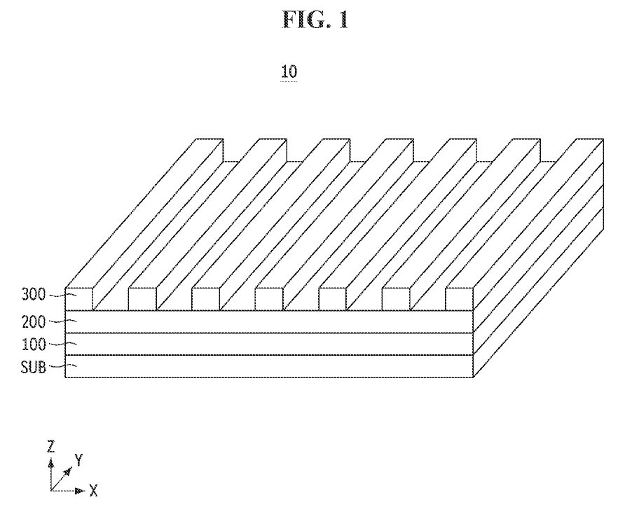

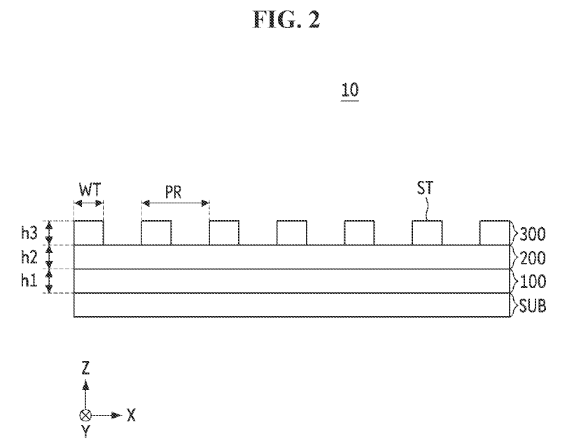

FIG. 1 is a perspective view illustrating an optical filter according to some embodiments of the disclosure. FIG. 2 is a front view illustrating an example of the optical filter of FIG. 1.

Referring to FIGS. 1 and 2, an optical filter 10 according to some embodiments of the disclosure includes a substrate SUB, a first layer 100, a second layer 200, and a third layer 300.

The substrate SUB may be made of a material having high transmittance (e.g., high light transmittance), such as glass and/or plastic. The substrate SUB may be a rigid substrate, and may be formed such that its one surface is flat.

The first layer 100 may be on one surface of the substrate SUB. The first layer 100 may include yttrium oxide (Y₂O₃). A refractive index of the first layer 100 may be in a range from about 1.9371 to about 1.9504. The refractive index of the first layer 100 may suitable vary depending on a wavelength band passing through the first layer 100. For example, the refractive index of the first layer 100 may be 1.9412 for red light having a wavelength of 639 nm, the refractive index of the first layer 100 may be 1.9371 for green light having a wavelength of 545 nm, and the refractive index of the first layer 100 may be 1.9504 for blue light having a wavelength of 488 nm, but embodiments of the present disclosure are not limited to a specific wavelength band.

The first layer 100 may have a first height h1. The first height h1 may be, for example, in a range from 85 nm to 87 nm, but is not limited thereto.

The second layer 200 may be on one surface of the first layer 100. A planar shape of the second layer 200 may follow a planar shape of the first layer 100. For example, the planar shape of the second layer 200 and the planar shape of the first layer 100 may be square, but are not limited thereto. The second layer 200 may include hafnium oxide (HfO2). A refractive index of the second layer 200 may be in a range from about 1.8943 to about 1.9116. For example, the refractive index of the second layer 200 may be 1.8943 for red light having a wavelength of 639 nm, the refractive index of the second layer 200 may be 1.903 for green light having a wavelength of 545 nm, and the refractive index of the second layer 200 may be 1.9116 for blue light having a wavelength of 488 nm, but embodiments of the present disclosure are not limited to a specific wavelength band.

The second layer 200 may have a second height h2. The second height h2 may be, for example, in a range from 78 nm to 80 nm, but is not limited thereto.

The third layer 300 may be on one surface of the second layer 200. The third layer 300 may include a plurality of structures ST spaced apart from each other in a first direction (X-axis direction) and extended in a second direction (Y-axis direction). The third layer 300 may include aluminum oxide (Al₂O₃). A refractive index of the third layer 300 may be in a range from 1.6769 to 1.6881. For example, the refractive index of the third layer 300 may be 1.6769 for red light having a wavelength of 639 nm, the refractive index of the third layer 300 may be 1.6829 for green light having a wavelength of 545 nm, and the refractive index of the third layer 300 may be 1.6881 for blue light having a wavelength of 488 nm, but embodiments of the present disclosure are not limited to a specific wavelength band.

The third layer 300 may have a third height h3. The third height h3 may be, for example, in a range from 98 nm to 100 nm, but is not limited thereto.

The plurality of structures ST may be spaced apart from each other by a first interval PR in the first direction (X-axis direction). In more detail, a distance between left sides of each of the plurality of structures ST may be constant (e.g., substantially constant) at the first interval PR. For example, the first interval PR may be in a range from 299 nm to 301 nm.

A width WT of each of the plurality of structures ST may be half of the first interval PR. For example, the width WT of each of the plurality of structures ST may be 150 nm, and the first interval PR may be 300 nm. As another example, a ratio of an area in which the plurality of structures ST are provided to an area of the third layer 300 may be in a range from 0.48 to 0.52.

The first height h1, the second height h2, the third height h3, and the first interval PR may be modified to be values proportional to one another. For example, the first height h1 may be 86 nm, the second height h2 may be 79 nm, the third height h3 may be 99 nm, and the first interval PR may be 300 nm.

As another example, the first height h1, the second height h2, the third height h3, and the first interval PR may be modified to be values that are 1.1 times of the above example. In embodiments, the first height h1 may be 94.6 nm, the second height h2 may be 86.9 nm, the third height h3 may be 108.9 nm, and the first interval PR may be 330 nm. If (e.g., when) the first height h1, the second height h2, the third height h3, and the first interval PR are lengthened, the wavelength of light reflected by the optical filter 10 may be lengthened.

As an example, the first height h1, the second height h2, the third height h3, and the first interval PR may be modified to be values that are 0.9 times of the above example. In embodiments, the first height h1 may be 77.4 nm, the second height h2 may be 71.1 nm, the third height h3 may be 89.1 nm, and the first interval PR may be 270 nm. As described above, if (e.g., when) the first height h1, the second height h2, the third height h3, and the first interval PR are shortened, the wavelength of light reflected by the optical filter 10 may be shortened.

The optical filter 10 of embodiments of the disclosure may reflect only light of a set or specific wavelength, such as a photonic crystal, by stacking the first layer 100, the second layer 200, and the third layer 300, which have refractive indexes different from one another, and forming the third layer 300 in a stripe pattern.

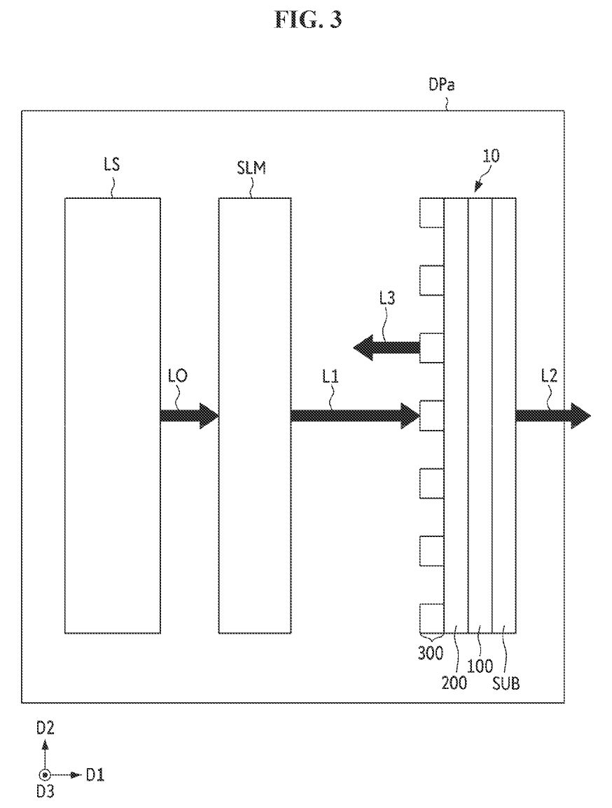

FIG. 3 is a side view illustrating a display device including an optical filter according to some embodiments of the disclosure. Redundant portions of those described above may not be repeated or briefly described, and differences from the above-described portions will be mainly described.

Referring to FIG. 3, a display device DPa according to some embodiments of the disclosure may include a light source LS, a spatial light modulator SLM, and an optical filter 10.

The light source LS may output first light L0. For example, the light source LS may be a laser, but is not limited thereto. If (e.g., when) the light source LS is a laser, the first light L0 may be coherent light having matching phases. The light source LS may output the first light L0 in a fourth direction D1.

The spatial light modulator SLM may be provided at one side of the light source LS. The spatial light modulator SLM may be provided in parallel (e.g., substantially in parallel) with the light source LS. The first light L0 output from the light source LS may be provided to the spatial light modulator SLM. The first light L0 may be vertically incident on the spatial light modulator SLM. The spatial light modulator SLM may modulate phase or amplitude of the first light L0 to output second light L1. The spatial light modulator SLM may output the second light L1 in the fourth direction D1.

Although the spatial light modulator SLM is shown as a transmissive spatial light modulator that outputs the second light L1 in the same direction as a moving direction of the first light L0, but embodiments of the present disclosure are not limited thereto. As another example, the spatial light modulator SLM may output the second light L1 in a direction opposite to the moving direction of the first light L0. In embodiments, the spatial light modulator SLM may be a reflective spatial light modulator.

In embodiments, a polarizing member may be additionally provided between the light source LS and the spatial light modulator SLM or between the spatial light modulator SLM and the optical filter 10. The optical filter 10 may receive light polarized in a set or specific direction through the polarizing member.

The optical filter 10 may be provided at one side of the spatial light modulator SLM. In embodiments, the optical filter 10 may be provided such that the third layer 300 is directed toward the spatial light modulator SLM. For example, the plurality of structures of the third layer 300 may extend in a sixth direction D3, and may be spaced apart from each other in a fifth direction D2. The optical filter 10 may be provided to be parallel (e.g., substantially parallel) with the spatial light modulator SLM. The second light L1 output from the spatial light modulator SLM may be provided to the optical filter 10. The second light L1 may move in the fourth direction D1.

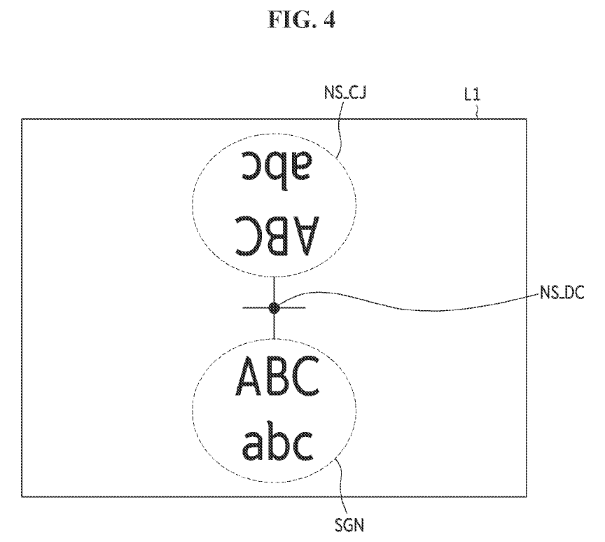

The optical filter 10 may transmit (L2) or reflect (L3) a portion of the second light L1. In embodiments, a portion of the second light L1 may be vertically incident on the optical filter 10. This will be further described herein with reference to FIGS. 4 to 9.

FIG. 4 is an example view illustrating an example of the second light of FIG. 3.

Referring to FIG. 4, the second light L1 may include a signal SGN, a conjugate noise NS_CJ, and a direct current noise NS_DC.

The signal SGN, which is a target to be provided to a user, may be a holographic image modulated in phase or amplitude while passing through the spatial light modulator SLM. The signal SGN may be spaced apart from an optical axis of the spatial light modulator SLM. Accordingly, the signal SGN may be obliquely incident on the optical filter 10.

The conjugate noise NS_CJ is an image in which the signal SGN is originally symmetric with respect to the optical axis, and may be generated by an imaginary portion in the process of expressing a phase of a hologram. Accordingly, the conjugate noise NS_CJ may be obliquely incident on the optical filter 10. A distance between the signal SGN and the conjugate noise NS_CJ may vary depending on an interval between pixels of the spatial light modulator SLM.

The direct current noise NS_DC may be generated due to light that is not modulated in the spatial light modulator SLM. The direct current noise NS_DC may be on the optical axis of the spatial light modulator SLM. Accordingly, the direct current noise NS_DC may be vertically incident on the optical filter 10. Because the direct current noise NS_DC is very bright, if (e.g., when) the direct current noise NS_DC enters a user’s pupil, the direct current noise NS_DC may interfere with the user’s observation of the signal SGN.

The optical filter 10 of the disclosure may reflect the direct current noise NS_DC of the incident second light L1 and transmit the remaining light, for example, the signal SGN and the conjugate noise NS_CJ. The conjugate noise NS_CJ may be filtered by any suitable method generally used in the art, such as being separated later through phase shift modulation using a carrier wave.

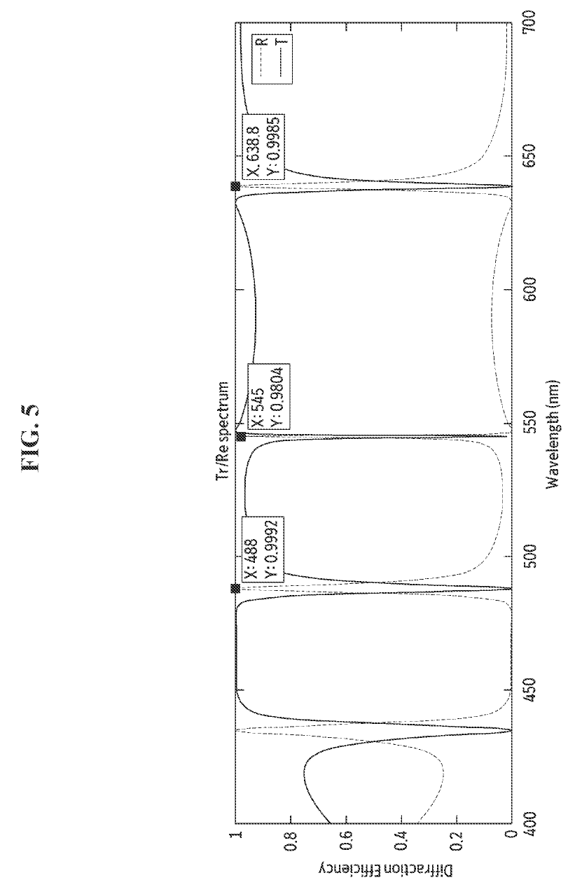

FIG. 5 is a graph illustrating transmittance and reflectance of the optical filter of FIG. 1.

FIG. 5 illustrates transmittance and reflectance of the optical filter 10 in which the first height h1 is 86 nm, the second height h2 is 79 nm, the third height h3 is 99 nm, and the first interval PR is 300 nm. As detailed values of the first height h1, the second height h2, the third height h3, and the first interval PR are changed, the wavelength of light reflected by the optical filter 10 may be changed.

Referring to FIG. 5, the optical filter 10 may reflect three wavelengths in a visible wavelength band of about 380 nm to 780 nm, and transmit the remainder.

For example, the optical filter 10 may reflect red light having a wavelength of 638.8 nm, green light having a wavelength of 545 nm, and blue light having a wavelength of 488 nm. Accordingly, the optical filter 10 may be used as a color filter that reflects light of a set or specific wavelength if (e.g., when) light in which several wavelength bands are mixed is incident.

If (e.g., when) the values of the first height h1, the second height h2, the third height h3, and the first interval PR are increased, the wavelengths of red light, green light, and blue light, which are reflected by the optical filter 10, may be lengthened,

In embodiments, if (e.g., when) the values of the first height h1, the second height h2, the third height h3, and the first interval PR are reduced, the wavelengths of red light, green light, and blue light, which are reflected by the optical filter 10, may be shortened.

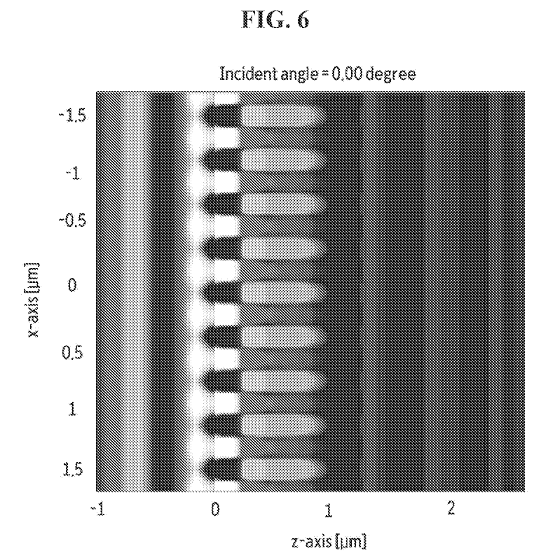

FIGS. 6 to 8 are views illustrating transmission and reflection with respect to an incident angle of the optical filter of FIG. 1.

FIG. 6 is a view illustrating transmissive light and reflective light if (e.g., when) an angle between the optical axis of the second light L1 incident on the optical filter 10 and a normal line of the optical filter 10 is 0°, for example, the incident angle is 0° in which light is vertically incident.

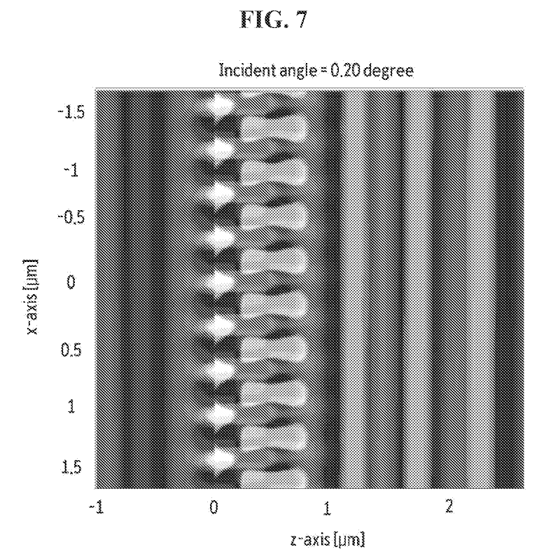

FIG. 7 is a view illustrating transmissive light and reflective light if (e.g., when) the angle between the optical axis of the second light L1 incident on the optical filter 10 and the normal line of the optical filter 10 is 0.2°, for example, the incident angle is 0.2°.

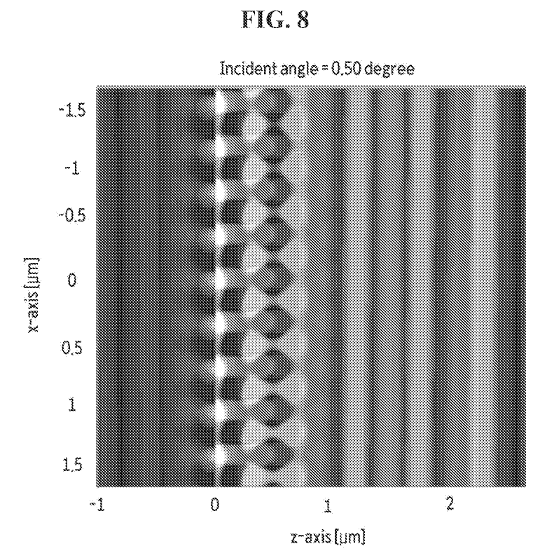

FIG. 8 is a view illustrating transmissive light and reflective light if (e.g., when) the angle between the optical axis of the second light L1 incident on the optical filter 10 and the normal line of the optical filter 10 is 0.5°, for example, the incident angle is 0.5°.

Referring to FIG. 6, in case of the second light L1, which is vertically incident, there is almost no light that passes through the optical filter 10.

Referring to FIG. 7, if (e.g., when) the incident angle is 0.2°, the optical filter 10 may transmit a portion of light and reflect the remaining portion thereof.

Referring to FIG. 8, if (e.g., when) the incident angle is 0.5°, the intensity of the transmissive light transmitted by the optical filter 10 may be further increased compared to FIG. 7, and the intensity of the reflective light reflected by the optical filter 10 may be reduced compared to FIG. 7.

Therefore, the optical filter 10 of embodiments of the disclosure may reflect vertically incident light (e.g., direct current noise) and transmit obliquely incident light (e.g., signal or conjugate noise).

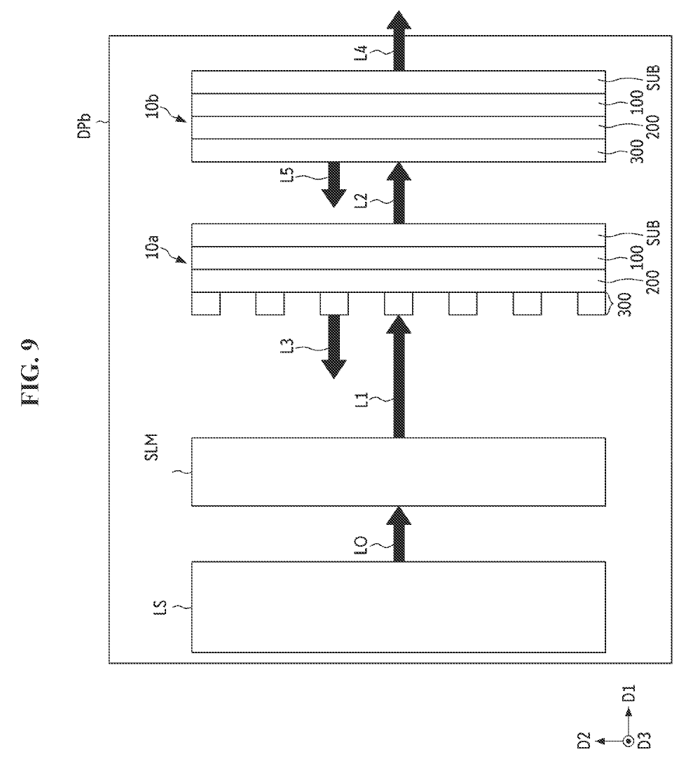

FIG. 9 is a side view illustrating a display device including an optical filter according to some embodiments of the disclosure. Redundant portions of those described above will be omitted or briefly described, and differences from the above-described portions will be mainly described.

Referring to FIG. 9, a display device DPb according to some embodiments of the disclosure may include a light source LS, a spatial light modulator SLM, a first optical filter 10a, and a second optical filter 10b.

The light source LS, the spatial light modulator SLM, and the first optical filter 10a may be substantially the same as those described above with reference to FIG. 3, and thus duplicative description thereof may not be repeated here.

The second optical filter 10b may include a substrate SUB, a first layer 100, a second layer 200, and a third layer 300. The second optical filter 10b may be formed to be the same as the first optical filter 10a. In more detail, a first height of the first layer 100 of the second optical filter 10b may be the same as the first height h1 of the first layer 100 of the first optical filter 10a. A second height of the second layer 200 of the second optical filter 10b may be the same as the second height h2 of the second layer 200 of the first optical filter 10a. A third height of the third layer 300 of the second optical filter 10b may be the same as the third height h3 of the third layer 300 of the first optical filter 10a. A first interval of the third layer 300 of the second optical filter 10b may be the same as the first interval PR of the third layer 300 of the first optical filter 10a.

The second optical filter 10b may be provided such that the third layer 300 of the second optical filter 10b is directed toward the first optical filter 10a. The second optical filter 10b may be provided to be parallel (e.g., substantially parallel) with the first optical filter 10a.

The second optical filter 10b may be provided such that an extension direction of a plurality of structures of the third layer 300 of the second optical filter 10b is different from an extension direction of a plurality of structures ST of the third layer 300 of the first optical filter 10a.

For example, if (e.g., when) the plurality of structures of the third layer 300 of the first optical filter 10a extend in the sixth direction D3, the first optical filter 10a may reflect incident light that is vertically polarized (TE mode; transverse electric field). The first optical filter 10a may reflect fourth light L3 that is vertically polarized, and may transmit the remaining light, third light L2, with respect to the second light L1 that is not polarized.

Subsequently, if (e.g., when) the plurality of structures of the third layer 300 of the second optical filter 10b extend in the fifth direction D2 perpendicular (e.g., substantially perpendicular) to the sixth direction D3, the second optical filter 10b may reflect incident light that is horizontally polarized (TM mode; transverse magnetic field). The second optical filter 10b may reflect sixth light L5 that is horizontally polarized, and may transmit the remaining light, fifth light L4, with respect to the third light L2.

In embodiments, if (e.g., when) the optical filters 10a and 10b having different extension directions of the plurality of structures of the third layer 300 are provided in parallel (e.g., substantially in parallel), the direct current noise NS_DC may be reflected without restrictions in the polarization direction of light provided from the spatial light modulator SLM.

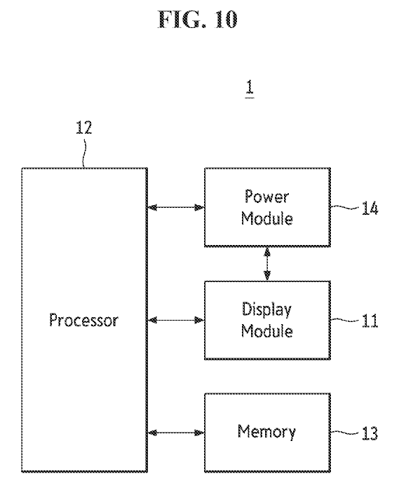

FIG. 10 is a block diagram illustrating an electronic device including a display device including an optical filter according to some embodiments of the disclosure.

Referring to FIG. 10, an electronic device 1 according to some embodiments of the disclosure may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), or a controller.

Data information utilized or required for an operation of the processor 12 or the display module 11 may be stored in the memory 15. If (e.g., when) the processor 12 executes an application stored in the memory 15, an image data signal and/or an input control signal is transmitted to the display module 11, and the display module 11 may process the received signal and output image information through a display screen.

The power module 14 may include a power supply module such as, for example, a power adapter or a battery device, and a power conversion module that converts a power source supplied by the power supply module to generate a power source utilized or required for the operation of the electronic device 1.

At least one of the respective components of the above-described electronic device 1 may be included in the display device according to the above-described embodiments. Also, some of the individual modules functionally included in one module may be included in the display device, and others thereof may be provided separately from the display device. For example, the display device includes the display module 11, and the processor 12, the memory 13 and the power module 14 may be provided as other devices in the electronic device 1 not the display device.

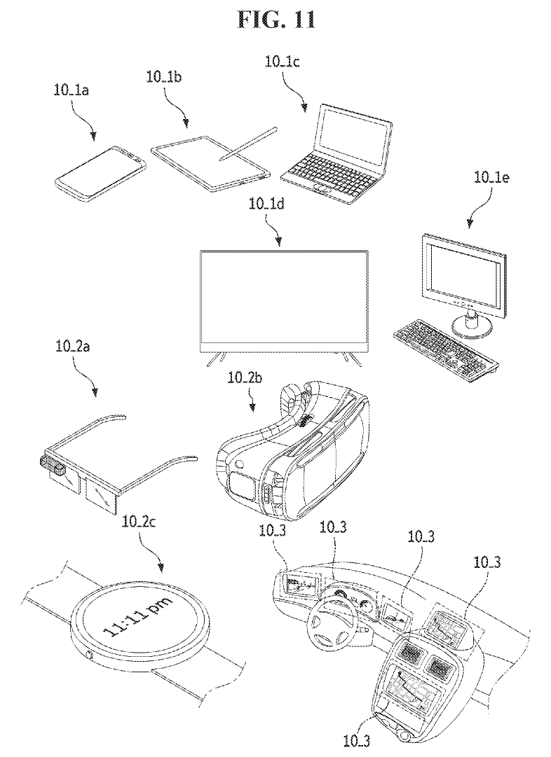

FIG. 11 is an example view illustrating an electronic device including a display device including an optical filter according to some embodiments of the disclosure.

Referring to FIG. 11, various suitable electronic devices to which the display devices according to embodiments of the present disclosure are applied may include not only electronic devices for image display, such as a smart phone 10_1a, a tablet PC 10_1b, a laptop 10_1c, a TV 10_1d, and a desk monitor 10_1e, but also wearable electronic devices including display modules such as smart glasses 10_2a, a head mounted display 10_2b, and a smart watch 10_2c, a vehicle electronic device 10_3 including display modules such as a vehicle dashboard, a center fascia, a center information display (CID) on the dashboard, and a room mirror display.

It should be understood, however, that the aspects and features of embodiments of the present disclosure are not restricted to those set forth herein. The above and other aspects of embodiments of the present disclosure will become more apparent to one of ordinary skill in the art to which the present disclosure pertains by referencing the appended claims, with equivalents thereof to be included therein.

What is claimed is:

1. A display device comprising:
a light source that outputs light;
a spatial light modulator that modulates phase or amplitude of light output from the light source; and
an optical filter that filters light provided from the spatial light modulator,
wherein the optical filter comprises:
a substrate;
a first layer on one side of the substrate;
a second layer on the first layer; and
a third layer on the second layer,
wherein the first layer, the second layer, and the third layer comprise materials different from one another,
wherein a height of the first layer, a height of the second layer, and a height of the third layer are different from one another, and
wherein the third layer comprises a plurality of structures that extend in a first direction and that are provided in a second direction perpendicular to the first direction.

2. The display device of claim 1, wherein the height of the second layer and the height of the third layer are proportional to the height of the first layer.

3. The display device of claim 2, wherein the height of the first layer is in a range from 85 nm to 87 nm.

4. The display device of claim 2, wherein the height of the second layer is in a range from 78 nm to 80 nm.

5. The display device of claim 2, wherein the height of the third layer is in a range from 98 nm to 100 nm.

6. The display device of claim 1, wherein the plurality of structures are respectively provided to be spaced apart from each other by a first interval in the second direction.

7. The display device of claim 6, wherein the height of the first layer, the height of the second layer, and the height of the third layer are proportional to the first interval.

8. The display device of claim 6, wherein the first interval is in a range from 329 nm to 331 nm.

9. The display device of claim 6, wherein a width of each of the plurality of structures is half of the first interval.

10. The display device of claim 6, wherein a ratio of an area in which the plurality of structures are provided to an area of the third layer is in a range from 0.48 to 0.52.

11. The display device of claim 1, wherein the spatial light modulator is a reflective spatial light modulator that reflects the light.

12. The display device of claim 1, wherein the spatial light modulator is a transmissive spatial light modulator that transmits the light.

13. An electronic device comprising a display device,
wherein the display device comprises:
a light source that outputs light;
a spatial light modulator that modulates phase or amplitude of light output from the light source; and
an optical filter that filters light provided from the spatial light modulator,
wherein the optical filter comprises:
a substrate;
a first layer on one side of the substrate;
a second layer on the first layer; and
a third layer on the second layer,
wherein the first layer, the second layer, and the third layer comprise materials different from one another,
wherein a height of the first layer, a height of the second layer, and a height of the third layer are different from one another, and
wherein the third layer comprises a plurality of structures that extend in a first direction and that are provided in a second direction perpendicular to the first direction.

14. An optical filter comprising:
a substrate;
a first layer on one side of the substrate;
a second layer on the first layer; and
a third layer on the second layer,
wherein the first layer, the second layer, and the third layer comprise materials different from one another,
wherein a height of the first layer, a height of the second layer, and a height of the third layer are different from one another, and
wherein the third layer comprises a plurality of structures that extend in a first direction and that are provided in a second direction perpendicular to the first direction.

15. The optical filter of claim 14, wherein the height of the second layer and the height of the third layer are proportional to the height of the first layer.

16. The optical filter of claim 15, wherein the height of the first layer is in a range from 85 nm to 87 nm.

17. The optical filter of claim 15, wherein the height of the second layer is in a range from 78 nm to 80 nm.

18. The optical filter of claim 15, wherein the height of the third layer is in a range from 98 nm to 100 nm.

19. The optical filter of claim 14, wherein the plurality of structures are respectively provided to be spaced apart from each other by a first interval in the second direction.

20. The optical filter of claim 19, wherein the first interval is in a range from 329 nm to 331 nm.
